(19) United States
(12) Patent Application Publication
(10) Pub. No.: US 2006/0173084 A1
(43) Pub. Date: Aug. 3, 2006

(54) Bipolar membrane and method of making same

(76) Inventors: Yongchang Zheng, Watertown, MA (US); Russell J. MacDonald, Wilmington, MA (US); Yuander A. Ju, Andover, MA (US); Keith J. Sims, Wayland, MA (US)

Correspondence Address: Schwegman, Lundberg, Woessner & Kluth, P.A., P.O. Box 2938, Minneapolis, MN, 55402, US

(21) Appl. No.: 11/293,873

(22) Filed: Dec. 2, 2005

Related U.S. Application Data
(63) Continuation of application No. PCT/US05/22737, filed on Jun. 23, 2005.
(60) Provisional application No. 60/583,220, filed on Jun. 25, 2004.

(51) Int. Cl. C08J 5/20

(52) U.S. Cl. 521/27

(57) ABSTRACT

A sheet having anion exchange functionality and a sheet having cation exchange functionality are juxtaposed and joined by current bonding into a unitary bipolar membrane. This may be done without added reactants or bonding agents by placing the two-layer assembly between opposed electrodes in a fluid cell, preferably at pressure, and applying power across the cell to split water in a junction region of the membrane assembly. Preferably the anion exchange sheet is treated with an iron salt solution so as to incorporate or immobilize the metal in the polymer during the current bonding process, and enhance operating characteristics of the bipolar junction. Membrane peel strength is comparable to or greater than that of an underlying sheet of ion exchange material, but the bonding is fully reversible, e.g., by soaking in a concentrated solution. Preferably both sheets include an aromatic backbone or cross-linker component. One membrane may be a self supporting membrane, such as a conventional electrodialysis exchange membrane of 5-50 mil (0.12-1.2 mm) thickness, while the other may also be a commercial membrane of opposite exchange type and of similar strength or thickness, or may be specially manufactured to tailor its performance in the completed membrane. For example, one or both starting sheets may be manufactured with a pore former or may otherwise have its porosity, cross-linking, strength, ion rejection characteristics or thickness tailored for more effective bipolar operation—for example, to enhance transport or diffusion, resist shear or mechanical forces, improve chemical resistance to splitting products or species in the intended feed, or the like. Preferably, prior to contacting and bonding, the anion exchange membrane is treated with a group VIII metal salt. The current-bonded unitary bilayer construction remains contact bonded over its surface and resists degradation in normal use.

### TECHNICAL FIELD AND BACKGROUND OF THE INVENTION

The present invention relates to so-called bipolar (BP) membranes, e.g., to sheets having a first layer or side (face) formed of material with cation-exchange functionality, and a second layer or side (face) with anion-exchange functionality. Each of the two different layers of ion exchange material is porous or otherwise somewhat permeable to a neutral fluid by virtue of its chemistry, physical structure and degree of cross-linking, and each layer possesses ion exchange functionality that operates to transport one type of ion across the material in an electric field, while substantially or effectively blocking most ions of the opposite polarity. With the two materials of different exchange type positioned face-to-face in adjacent layers, ions are effectively “blocked” by one or the other layer and thus cannot traverse the sheet. The interfacial or intermediate region, e.g., the internal plane running parallel to and between the two outer surfaces of the bipolar membrane, is called the junction region, and this may, in various known methods of bipolar manufacture include a gel, powdered exchange resin or other active material, and/or may be treated or assembled with agents that form a gel in that region, and/or may formed with structural features such as grooves or channels, to enhance its conductivity, permeability, gas transport out of the junction region or other structural and/or physico-chemical property. The junction region is generally quite thin.

When a bipolar membrane is immersed in a fluid such as an aqueous solution and a potential is applied across the membrane, the oppositely-oriented ionic conductivity of the two sides of the membrane substantially prevents the transport of dissolved ions of both positive and negative charge toward the junction region, so that the water diffusing into that region carries primarily non-ionized solutes and has low conductivity. The potential across the thin junction region then effectively ionizes (splits) the fluid. As water dissociates into hydroxyl and hydronium ions in the junction region, the two ions are captured and transported toward the corresponding electrodes, out through the opposite sides of the membrane.

A bipolar membrane may thus function as a localized source of hydroxyl and hydronium ions, presenting them separately to the opposite sides of the membrane, for example to two different flow or treatment cells bounded by the membrane. This operational feature has been applied in many designs for specialized electrodialysis processes and equipment. One general architecture of this type is an ion-exchange membrane electrodialysis unit configured to split an ionizable material such as a salt solution, and simultaneously generate hydroxyl and/or hydronium ions in a bipolar membrane bordering the separated anion and/or cation streams. The generated ions then combine with the separated salt components to form a corresponding acid stream, base stream, or both. Such processes may be used to extract, refine, concentrate or modify various products or substances. Such constructions may also be used to maintain a desired pH condition during electrodialysis, or create suitable gradients for isoelectric separation of biomaterial, such as protein separation.

These BP membrane-based constructions and treatment processes, while conceptually elegant, have in practice encountered a number of potential problems or limitations, and for various reasons bulk processing applications of this type have experienced rather limited commercial use in the period since their initial discovery, promotion and practical implementation.

Generally, unless an electrodialysis (ED) system operates on a solution having an extremely limited amount of solute (such as a clean water that is to be demineralized for UPW use), the feed or concentrate streams may have to be recirculated many time to effect a desired degree of de-salting, acidification or other intended treatment. When the feed stock is to be a relatively concentrated solution, and when many kilograms of a product are to be recovered or treated, a treatment that relies on electrically driven membrane transport processes and electrolytically-generated species to replace a conventional chemical separation and conversion processes of acid- or base-addition, or to replace a system that relies upon capture and transport by ion exchange resins, will incur significant costs for electrical energy and the capital and operating costs of necessary membranes and equipment. It is therefore important that the bipolar membranes used for such processes possess relatively good current efficiency and that they be robust, maintain a high degree of physical integrity and be able to sustain their level of performance. The underlying exchange layers or coatings must be relatively efficient at blocking back-diffusion and at preventing undesired recombination events.

One factor that may physically affect a bipolar membrane is uncontrolled or excessive current, which may lead to extremes of pH near the splitting junction, causing membrane destruction, initiating scaling or causing other interfering deposits or reactions. The effects may be compounded if certain ions are present in the feed. Some neutral matter that may be present in the feed (such as a dissolved gas like CO₂), may diffuse into the junction region, and then react or precipitate on or within the membrane, impairing its operation. Excessive water splitting may lead to recombination and the release of gas that reacts, forms bubbles or otherwise degrades or contributes to delamination of the two exchange materials. When water is unable to diffuse into the junction sufficiently quickly, or when the species resulting from water splitting are not transported out at a sufficient rate, extreme conditions, or exotic or reactive species may arise that damage the membrane or impair its operation. The susceptibility to such effects, or the performance or overall capacity of the bipolar membrane, may be “diffusion-limited”, and thus, for given materials, may vary with the thickness of the membrane and its nominal permeability or ion transport qualities. Performance may also be affected by the effectiveness of the membrane at blocking counter-ions, it's overall exchange capacity, or other factors. Moreover, when used to treat a product stream, all the characteristics and potential problems associated with conventional electrodialysis membranes—control of fouling and scaling, avoidance of chemical degradation and the like—may need to be addressed.

Much has been published about existing technologies for forming bipolar membranes. One may reasonably expect the characteristics of a membrane, and the effectiveness and characteristics of the junction between the two regions of opposite ion exchange type, to depend on the chemistry of the underlying ion exchange materials and the processes employed to produce the membrane or bipolar assembly.

A number of early BP membranes were formed by bonding together two self-supporting (and necessarily thick) conventional ion exchange membranes of opposite type. This approach has an advantage that it uses membranes with proven integrity and strength, each possessing a largely known operating range, spectrum of field characteristics and range of cleaning protocols. However, two pre-existing commercial monopolar membranes are not necessarily well adapted for the different mechanisms operative in bipolar operation, and the process of cementing or coating, casting and/or attaching the membranes together may itself impose limits on the achievable operating characteristics. The bipolar assembly might not permit adequate water inflow to, or sufficient hydroxyl/hydronium transport from, the junction; or might prove unsuited to certain materials or environments, or might give rise to, and have limited tolerance for, extremes of pH. For a given feed, it may perform poorly at selecting or passing an intended species, or at blocking certain ions. Joining the membranes may be problematic, and may require strong solvents, physical preparation (such as surface roughening or caustic digestion), and reactive agents and/or cements or bonding materials having undesirable characteristics or effects. It may be necessary to enhance the exchange or splitting activity of the junction region by physically incorporating a fine powder of ion exchange or chemically active material to form a dispersion of exchange heterojunctions or other active loci, or by applying a chemically-tailored polymeric coating in that region. Another method of making these membranes has been to soak separate anion and cation exchange membranes in suitable salts and then join them by forming a gel in the interface region.

One BP membrane manufacturing process has relied upon manufacture wherein one exchange material is cast, coated, formed or otherwise deposited as a layer or coating of exchange material on one side of a supporting membrane formed of the opposite exchange type material. In that case, only the first membrane need be self-supporting, and a relatively thin exchange coating may constitute the other surface. Form-in-place or coating manufacturing processes allow the applied surface to be more readily tailored—for example to have an anti-fouling, species-selective, or temperature-resistant characteristic for dealing with certain properties of the feed or the treatment environment. On the other hand, although a coating process may allow one to form a surface exchange layer with somewhat customized properties, one should conduct suitable experimentation in order to achieve suitable adhesion, strength and activity of the coating together in conjunction with a effective bipolar junction and operating characteristics. Thinner coating constructions may lack strength or durability, and be more subject to wear, deterioration or erosion if placed in the relatively harsh or reactive operation and somewhat abrasive process flows (typically including mixed-type feed, waste, salt or chemical product streams) with which bipolar electrodialysis units have been promoted for commercial operations. It has also been proposed to provide a raw membrane of suitable polymer chemistry, and to then introduce cation and anion exchange functionality to opposite faces of the membrane, by coating/reaction processes generally similar to processes conventionally employed in the fabrication of ion exchange material. While this method of manufacture should avoid problems of delamination, it would appear to require careful sequencing of steps and tight process control to achieve a well-defined junction, and to avoid formation of a non-functionalized interior, or a region of graded or even mixed exchange type.

Thus, it may be said that a number of bipolar membrane constructions and processes are known but these are subject to limitations and face a large spectrum of requirements. Correspondingly, once several generally necessary properties of a bipolar membrane have been adequately addressed, the application of the membrane a to a specific treatment stream may raise a number of technical problems specific to that feed stream. A number of early applications of bipolar membrane electrodialysis addressed high value treatment problems in areas where earlier work provided some guidance, such as the treatment of hydrofluoric acid wastes when earlier electrodialysis systems had been used as acid/base concentrators. Subsequently, while theoretical and experimental investigations in bipolar electrodialysis and its applications to different feed streams have flourished, there appear to have been relatively few pilot scale operations, and only a handful of industrial-scale treatment or production plants using this technology actually built or remaining in operation. Some of the plants so constructed may have been built and extensively supported by a membrane manufacturer hoping to perfect a process and thereby create a specific large-scale and commercially-viable application market. Market or other considerations may have motivated the opening or the closing down of a given plant. It would be difficult to generalize, because public information regarding operation of commercial plants can be anecdotal and details may remain largely confidential, while production decisions may hinge on business factor unrelated to the underlying technology. Still, it is known that a number of the bipolar treatment plants that had been built in the last fifteen years are no longer in operation.

It would therefore be desirable to provide additional bipolar membrane fabrication processes.

It would also be desirable to provide new processes for manufacture of effective bipolar membranes.

It would also be desirable to provide bipolar membranes that are broadly compatible with a range of fluid feed streams and are suitable for industrial application to carry out bipolar electrodialysis treatment processes.

### SUMMARY OF INVENTION

Applicant has now found a method of producing an effective and robust bipolar membrane to address one or more of the foregoing goals. In accordance with one aspect of the present invention, a process for the manufacture of a bipolar membrane joins a first ion exchange sheet having anion exchange (AX) functionality and a second ion exchange sheet having cation exchange (CX) functionality by juxtaposing the two sheets and joining them to each other by an electrochemical operating procedure. The starting membranes of the membrane-pair are smooth-surfaced ion exchange sheets of homogeneous composition. By “homogeneous composition” is meant that it is not a heterogeneous sheet made of powdered exchange material and a binder, but is formed of exchange-functionalized polymerized cross-linked material; the sheets are “smooth” in that they have a smooth finish, without the granularity or roughness that is characteristic of heterogeneous membranes. The electrodialysis membranes sold by Ionics, Incorporated of Watertown, Mass. are examples of smooth homogeneous membranes. Smoothness of the membrane surface allows a very high degree of direct surface contact between the two sheets. Continuing with a description of the method of manufacture, the AX and CX sheets are placed in a two-layer assembly or “laminate” and are positioned between two electrodes in a fluid chamber. Current is then run through the two-membrane assembly, and this operation is continued at a current level for a sufficient time to bond the sheets together, becoming structurally integral (in the region of current flow) with an effective splitting or junction region internally thereof.

In a preferred embodiment, one or both sheets are treated with a metal salt, either by soaking or by coating, prior to the bonding procedure, and the bonding procedure is carried out to capture or immobilize the metal species of the salt in the bipolar membrane. Preferably the AX sheet is so treated by soaking in a metal salt solution. Applicant has found that metal immobilized in the membrane promotes a low voltage drop and enhances current characteristics. The metal is preferably a transition metal, that may exist in higher valence states, a property that is hypothesized to enhance operation of the junction region between the sheets, possibly because the precipitate exists in a polar form that may affect conformation of the relatively polar exchange groups present in the molecular structure of each membrane, or may participate in or catalyze the functional exchange, or electron and/or other transport processes at the junction. Without limiting the invention to a particular theory, the presence of a multivalent metal such as iron species in the junction region is believed to promote an effective operation of the material in the anion and cation exchange junction region, possibly by a mechanism such as by providing multiple ionic or polar sites (such as hydroxyl groups) that facilitate the fit of the opposed membranes at the polymer molecule level or the splitting of water and/or transport of split components to opposite membranes. The intermembrane junction so formed is highly stable under normal operating conditions.

The electrochemical joining of the two sheets to form a bipolar membrane in accordance with a basic aspect of the invention is preferably carried out by operating the laminate assembly to split water and transport hydroxide and hydronium ions, respectively, out opposite sides thereof, at a current in excess of 30 ma/cm² for a time of more than a half hour. Preferably this operation above a threshold current is initially carried out for a period of several hours to several days, and most preferably, the process is performed to achieve a peel strength comparable to or greater than that of at least one of the starting sheets or membranes of ion exchange material. One or both of the starting membranes may contain unreacted functionality, and preferably both the first and the second exchange sheets are each cross-linked polymerized membranes having an aromatic co-monomer, cross-linker and/or other aromatic component. They may, for example, be styrene-DVB-based homogeneous ion exchange membranes, functionalized with sulfonic or with quaternary amine exchange groups, or with other appropriate exchange functionality. Preferably the homogeneous membranes each possess a smooth surface that enables essentially complete surface-to-surface contact over a broad area of the opposed faces of the two sheets. When an immobilized multivalent metal is employed, this is preferably a metal such as cobalt, nickel or iron.

In one embodiment of the invention, at least one of the starting sheets of exchange material may be a self supporting membrane, such as a conventional membrane 5-50 mils (0.1-1.3 mm) thick, having suitable strength and robustness to undergo general manipulation and steps such as soaking, clamping in a frame and other handling involved in the assembly of the membrane into and operation in an electrodialysis device. The other sheet need not (although it may) have comparable strength or thickness. Generally thinner sheets will have lower electrical resistance and shorter transport path length, but lower mechanical strength. Preferably the membrane or material has an exchange capacity of between about 0.5 and about 3.0 meq/gm. While the description herein of several examples will largely refer to use of sheets that are conventional membranes, i.e., are commercially-produced ion exchange membrane product, it is not necessary that either sheet be such a commercial membrane or have the strength or physico-chemical properties characteristic of existing membrane products. As compared to a standard industrial electrodialysis membrane, it may differ, in thickness, strength, exchange capacity, porosity or other characteristic so as to optimize the characteristics of the bipolar membrane assembled therefrom. Thus, one or both starting sheets may instead have its properties adjusted, as compared to the commercial ion exchange sheets described in examples below. For example, a sheet may be manufactured with a greater or lesser amount of pore former, or with different level of polymerization or cross-linking or different monomer or other components, may be manufactured to have a higher or lower level of unreacted sites, or of exchange functionality in its matrix material, or may otherwise have its porosity, strength, thickness, exchange capacity, transport number or other physical or chemical characteristics tailored for more effective operation as a bipolar splitting membrane.

The bipolar membrane is formed, as indicated above, by electrically joining an anion and a cation exchange sheet. Surprisingly, applicant has found that although the bonding is extremely strong, it may also be completely and non-destructively reversed. That is, the two sheets may be separated (delaminated) or detached from each other by the simple expedient of subsequently soaking or operating the bonded bipolar membrane in a concentrated salt solution. While the mechanisms of such separation are not fully known, it is believed that the occupation of exchange sites by the salt species serves to reduce the available attractive forces, and the physical shrinkage of the two substrate sheets generates shear and other mechanical forces sufficient to overcome the original binding. Moreover, since these effects occur uniformly over the exposed surface, they do not give rise to extreme forces that would tear or otherwise damage the underlying membranes. Thus, once separated, it is possible to again re-join the membranes by applying the electrochemical bonding procedure as described initially above. Thus, in these circumstances the layers are reversibly joined, e.g., an ephemeral splitting junction is formed.

### BRIEF DESCRIPTION OF THE DRAWINGS

These and other aspects of the invention will be understood from the description and claims herein, taken together with the drawings showing details of construction and illustrative embodiments, wherein:

FIG. 1 schematically illustrates manufacture of a bipolar membrane in accordance with one aspect of the present invention; and

FIG. 2 schematically illustrates a test apparatus set up to evaluate bipolar membrane performance.

### DETAILED DESCRIPTION

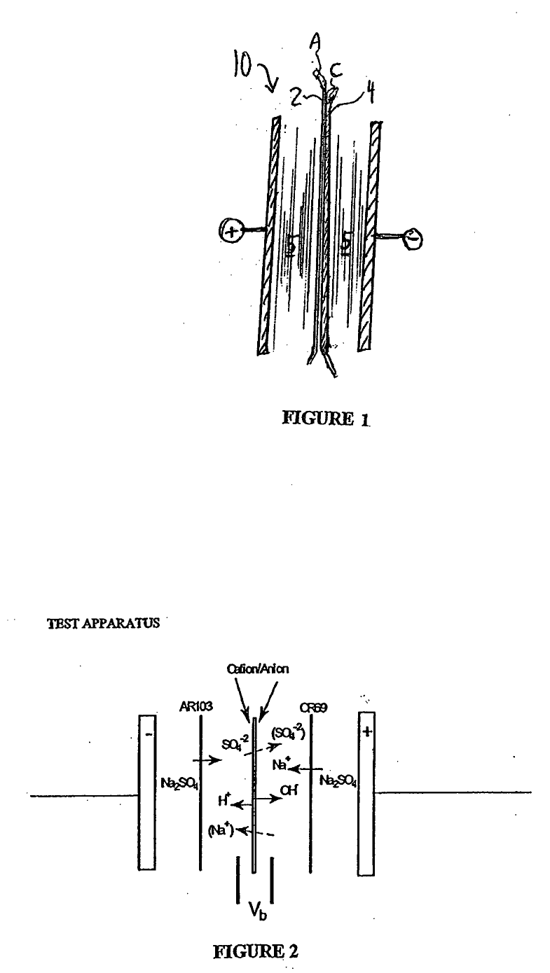

FIG. 1 schematically illustrates a process 10 for manufacturing a bipolar membrane in accordance with one aspect of the present invention. In broadest terms, the invention includes a process for joining a first sheet 2 of one exchange type, such as an anion exchange membrane, to a second sheet 4 of another exchange type, e.g., a cation exchange membrane. The two membranes are placed face-to-face in contact with each other, and bonding is effected by the operation of running current through the juxtaposed membranes in a conductive fluid environment 5 to form a strong bond, in a junction region, between the sheets, integrally and uniformly binding together the two sheets over their central area of contact and current flow. This bonding—termed “current bonding” or “electrical bonding” herein—has been unexpectedly found to result in bonding strengths comparable to the tear strength of an underlying membrane, such that physical separation of the two layers results in tearing, leaving a rough surface. The fluid environment may be provided by an electrode and frame structure set up to operate, in a manner similar to an electrodialysis cell or unit, in an aqueous fluid, and the current maybe substantially or entirely directed to splitting water in the interfacial region to provide ions that sustain a current flow through the membrane.

Preferably at least one of the sheets of exchange material is soaked in or coated with a metal salt, such as the salt of iron or a transition metal, prior to joining, and the joining process is carried out to incorporate metal species from the salt into the membrane structure of the bipolar membrane so produced. The incorporated metal species, which is preferably precipitated or immobilized at least in the surface of the anion exchange sheet, enhances bonding and/or enhances splitting operation, and is referred to herein as “catalyst”.

Each of the anion and cation sheets is preferably a homogeneous ion exchange membrane, and the bond formed between them, which appears somewhat similar to so-called “contact bonding” in the field of polished surfaces of certain solids, involves an intimate attachment of the surfaces of the two pieces. This bonding may involve Van der Wals forces and/or some physical or diffusive intermigration or interpenetration of substrate material from one exchange sheet into the other. Without limiting the invention to any proposed theory or mechanism, it is possible that the electrical operation increases a field-induced interdiffusion of one sheet into the other, and/or the formation of bonds, such as ionic bonds, at the molecular or functional group level, that advantageously result in a robust and well-defined junction region having a high degree of physical integrity while preserving the porosity and ion transport characteristics necessary for effective bipolar operation. The unitary membrane therefore enjoys good splitting characteristics, and is capable of high current operation and good efficiency.

A few examples will illustrate various considerations involved in production of the bipolar membrane, the current bonding or curing process, the included catalyst, and the characteristics of the bipolar membrane so made and its applications.

### EXAMPLE 1

### Making a Bipolar Membrane by Electrical Contact Bonding of Two Sheets

A cation exchange membrane having sulfonic groups as ion exchange groups (CR61CMP of Ionics, Incorporated of Watertown, Mass.) was cleaned with ultra pure water to prepare it for use as part of a bipolar membrane. The CR61CMP cation membrane is a homogeneous membrane composed of aromatic cross linker and aromatic sulfonic groups, with an ion exchange capacity of about 2.2 meq/g., a water content of about 43%, a resistivity of about 9.0 ohm-cm², and thickness about 0.060 cm.

An anion exchange membrane having quaternary ammonium groups as ion exchange groups (IONICS AR103QDP) was cleaned with ultra pure water to prepare it for use as another part of the bipolar membrane. The AR103QDP anion membrane is a homogeneous membrane composed of aromatic cross linker and aromatic quaternary ammonium groups, with an ion exchange capacity of about 2.2 meq/g, a water content about 36%, a resistivity of about 10.0 ohm-cm², and thickness about 0.06 cm.

A piece of the cation and a piece of the anion membrane approximately nine by ten inches were placed in facing layers as a bipolar laminate with an effective area of 232 cm². The bipolar laminate was then assembled in a frame structure, with a piece of cation membrane and a piece of anion membrane spaced therefrom defining fluid cells (e.g., so that repetition of the bipolar laminate/anion membrane/cation membrane three-membrane unit would form a repeating multichamber bipolar membrane electrodialysis cell arrangement. See, for example, U.S. Pat. No. 4,851,100 for a simple arrangement with acid-enriched and base-enriched flow cells separated by a common bipolar membrane). A small bipolar ED stack (“stack” or “stackpack”) was assembled having five of these bipolar cells plus an electrode cell at each end. This arrangement was plumbed with corresponding cells in parallel, and the stack was then operated with a pressure feed of a 7-12% NaCl solution through the middle chambers (e.g., between the cell bounded by the anion exchange and the cation exchange membrane, so that the Cl and Na ions were transported into respective first or second side chambers where they received a hydronium or hydroxide counter-ion from an adjacent bipolar membrane to form HCl or NaOH, respectively. The acid side chamber was started with ultra pure water then run with acid solution created by operation of the stack, and the caustic side chamber was started with ultra pure water and then run with caustic solution formed by operation of the stack. The cathode cell at one end of the stack was run with the same solution as the caustic chamber, and a one percent sulfuric acid solution was provided to the anode cell at the other end of the stack.

The stack was run under various conditions, at a current density of at least 15 mA/cm² and up to 100 mA/cm² for 150 minutes. The pressure of each chamber was controlled to be the identical, at about 10-15 psi. After the run, working solution was collected from the acid chamber, the caustic chamber and the feed chamber, and the volume and concentration that each solution had attained was measured. In some examples, the current efficiency was calculated from the Faraday number and the concentration of acid and caustic that had been created.

After the run, the stack was taken apart and the bipolar laminate was examined. The two membrane layers had bonded together, becoming a one piece bipolar membrane in the area of electric current passage. If the current density had been above 30 mA/cm², the bonding was strong; when the bonded bipolar membrane was peeled apart, a rough surface was seen on each separated membrane. Thus, the electric current made the cation and the anion membranes join together during the process of water splitting at the interface of bipolar membrane.

### COMPARATIVE EXAMPLE 1

A bipolar laminate was assembled with a piece of cation membrane and a piece of anion membrane, both of which were heterogeneous membranes with capacity about 2.0 meq/g and water content of approximately 30%. The procedure as described in Example 1 was carried out. After the run, the two membranes were found to not be bonded together. Inspection after separation of the membranes showed both surfaces to be smooth. A high voltage drop (>4.0 V at current density of 60 mA/cm²) was measured across the membranes.

### COMPARATIVE EXAMPLE 2

A bipolar laminate was assembled with a piece of cation membrane and a piece of anion membrane. The cation membrane was a homogeneous membrane composed of aliphatic crosslinker and aliphatic sulfonic groups with an ion exchange capacity of about 2.2 meq/g. and a water content of about 45%. The anion membrane was a homogeneous membrane composed of aliphatic crosslinker and aliphatic quaternary ammonium groups, with an ion exchange capacity of about 2.2 meq/g. and a water content of about 45%. The same procedure as described in Example 1 was carried out to bond the two membranes together. After the run, the two membranes had not bonded together, and upon separation were both observed to have smooth surfaces.

### EXAMPLE 2

### Bipolar Membrane with Catalyst

An anion exchange membrane having quaternary ammonium groups as ion exchange groups (IONICS AR103QDP) was cleaned with ultra pure water for use as one layer of bipolar laminate as described in Example 1. The anion membrane was soaked in a metal salt solution (such as NiCl₂, FeCl₂, FeCl₃, CoSO₄, SnCl₂, ZnCl₂ etc) at a concentration between about 0.1-1.0 N for between one hour and three days to saturate the anion membrane with the salt solution, in preparation for making a bipolar membrane.

A homogeneous cation membrane with aromatic crosslinker and aromatic sulfonic groups (CR61CMP) as described in Example 1 was placed against the metal salt treated anion exchange membrane to form a bipolar laminate, and this was then assembled with a piece of cation and a piece of anion membrane to form a bipolar membrane cell (or “bipolar unit”). A bipolar ED stack was made with five bipolar units between two electrode cells as described in Example 1. The feed chamber was run with 7-12% sodium chloride solution, while the acid chamber was started with ultra pure water then run with acid created during operation. The caustic chamber was started with ultra pure water and then run with caustic solution formed by operation of the stack. The cathode cell received the same solution as the caustic chambers, while the anode cell was run with a 1% sulfuric acid solution. The size of the membrane was 9″ by 10″, and its effective area 232 cm².

This stackpack was run at a current density of at least 15 mA/cm² to 100 mA/cm² for 150 minutes, and the pressure of each chamber was controlled to be the same, about 10-15 psi. After the run, solution was collected from the acid chamber, the caustic chamber and the feed chamber, and their volumes and concentrations measured, e.g., to calculate the current efficiency from the Faraday number and the concentration of acid and caustic that were formed.

After the run, the stackpack was disassembled and the bipolar laminates were examined. The two pieces of membrane had bonded together becoming a single bipolar membrane in the area of electrical current flow. The color of the anion side of the bipolar membrane had darkened, indicating presence of metal ions in the anion membrane and their change to metal hydroxide or metal oxide form. Metal ions in the anion membrane were believed to be acting as catalyst to lower the voltage drop of water splitting at the interface of the bipolar membrane.

### EXAMPLE 3

### Effect of Catalyst

A Lucite test cell was set up to measure the voltage drop (V_{b}) of the bipolar membrane using a capillary salt bridge electrode arrangement. The test cell consisted of cathode and anode electrodes of platinum-coated titanium located at the terminal ends of the cell with three membranes. The membranes were separated through four spacers to form four compartments or chambers in the following sequence or arrangement: the cathode, cathode compartment, commercial anion membrane (Ionics, AR103), compartment A, the bipolar membrane to be tested, compartment B, a commercial cation membrane (Ionics CR69 or CR61), the anode compartment and finally the anode. Two plastic capillary tubes were installed into the spacers next to the bipolar membrane and their ends were bent to position them immediately adjacent to the bipolar membrane surface close to the middle of the membrane. The other ends of the capillary tubes were connected with tubing to a small bottle containing 1 N KCl solution. An Ag/AgCl double junction electrode was placed in the bottle, and the two electrodes were connected to the voltage meter. The tubing from the capillary to the bottle was filled with 1 N KCl. The arrangement is shown in FIG. 3.

Each compartment had about 10 ml volume and 11.4 cm² cross sectional area. The electrode compartments were run with 1% NaSO₄ solution using a peristaltic pump at a flow rate 250 ml/min. The acid compartment started with 0.02 N sulfuric acid at the beginning of the run, and the caustic compartment started with 0.02 N NaOH solution at the beginning of the run. With the cell operating at a certain current density, the voltage drop across the bipolar membrane was monitored with a voltage meter connected through electrode/salt bridge/capillary arrangement. When the concentrations of the acid and caustic were built up to about 1 N, the voltage readings from the meter were taken as the bipolar membrane voltage drop measurement. These appear in TABLE 1, below. The various back-to-back (BtB) membranes formed in this way performed quite well as compared to the theoretical bipolar water splitting voltage of about 0.82V. In general the voltage measured for any actual bipolar membrane will be higher than the theoretical splitting voltage due to the membrane resistivity. The range of measured voltages shown in TABLE 1 are quite respectable for the prototype specimens prepared using commercial ion exchange membrane stock for the underlying sheets of excange material, and performance may be improved and optimized to obtain lower voltage drop and improve operation in various ways, as will be appreciated by those skilled in the art. The increase in (V_{b}) observed at higher currents is believed to result from factors affecting water transport, such as the porosity and membrane thickness, so that by changing the physico-chemical properties of one or both starting sheets, lower V_{b} may be maintained in higher current ranges. The bilayer construction allows relatively great leeway for adjustment of these parameters (compared to the standard commercial monopolar membranes), while achieving greater strength or thickness than prior art BP membrane manufacturing methods employing coating, form-in-place or surface functionalization approaches.

Voltage drop of bipolar membranes

| BP | 30 mA/cm² | 60 mA/cm² | 89 mA/cm² |
|---|---|---|---|
| BtB without catalyst | 1.89 | 2.21 | 2.75 |
| BtB w Fe⁺³ | 0.96 | 1.00 | 1.30 |
| BtB w Fe⁺² | 0.88 | 1.13 | 1.30 |
| BtB w Co⁺⁺ | 1.50 | 2.03 | 2.60 |

### EXAMPLE 4

### BtB bipolar membrane with Fe⁺⁺

A two-sheet laminate as described in Examples 1 and 2, with catalysts Fe⁺² was assembled in a stack consisting of 5 bipolar units with a special design that allowed the H⁺ and OH⁻ ions created from the cathode and anode to get in the acid and caustic chambers respectively, e.g., looking essentially like a 6 cell-pair bipolar membrane stack, with the following characteristics.

Bipolar membrane: CR61CMP/AR103QDP with Fe⁺² as catalyst

Running condition:
Number of cell pair: 5
Feed: 4 liter 7% of NaCl solution, 12% of NaCl for current density at 100 mA/cm²
Acid: 3 liter of water
Base: 3 liter of water
Electrode: 3 liter 1% of H₂SO₄
Cation: CR69EXMP
Anion: AR103QDP
Current density: 30, 60 or 100 mA/cm²
Running time: 150 min
Catholyte: H₂SO₄

Anolyte: Caustic

The stack was modeled as 6 cell pairs to calculate the current efficiency.

| Bipolar | V, | | Concentration, | CE, | Concentration | | P.C, HCl | P.C, NaOH | |
|---|---|---|---|---|---|---|---|---|---|
| Membrane | stack | CD, ma/cm2 | HCl, N | %, HCl | NaOH, N | CE, % NaOH | KWH/kg | KWH/kg | Power, KWH |
| BtB, Fe+2 | 14.5 | 30 | 0.83 | 72.0 | 0.85 | 76.4 | 2.59 | 2.23 | 0.267 |
| BtB, Fe+2 | 20.1 | 60 | 1.17 | 53.9 | 1.10 | 58.0 | 4.75 | 4.03 | 0.679 |
| BtB, Fe+2 | 24.6 | *100 | 1.60 | 42.5 | 1.42 | 46.8 | 7.32 | 6.09 | 1.43 |

### EXAMPLE5

### Recovery of ascorbic acid. BtB membrane with Co⁺⁺

This example reports the recovery of Ascorbic Acid from Sodium Ascorbate using back-to-back membranes of the invention, and using a commercially available bipolar membrane.

A 9×10 stackpack run was conducted on a sodium ascorbate feed, to convert it to ascorbic acid (Vitamin C, or “Vc”) using freshly made back-to-back bipolar membranes with catalyst. To evaluate performance, operation was compared to that of a commercial bipolar membrane (BP-1 membrane of Tokuyama Soda) run under similar conditions.

Stack configuration:

Bipolar membrane: 5 CR61CMP/AR103QDP or Tokuyama BP-1.

Cation membrane: 6 CR69EXMP, 9×10″.

The membranes were assembled as a two-compartment-cell stack. Sodium ascorbate (NaVc) was run in the acid chamber and converted to ascorbic acid. Sodium hydroxide was run in the caustic chamber and electrode chambers.

Running conditions:

| | NaVc, | NaOH | | Voltage | Current |
|---|---|---|---|---|---|
| | 1.26 N | (0.5 N), | Run Time, | of | density, |
| | (25%) ml | ml | min | stack, V* | mA/cm² |
| Back to back | 3000 | 3000 | 280 | 18-19 | 30 |
| Commercial | 3000 | 3000 | 280 | 12-13 | 30 |
| BP | | | | | |

*At current density 30 mA/cm² of the steady state.

Detailed results are shown in the Table below:

Back-to-back BP membrane

| | Time, min | Vol, ml | Conc, N | PH | | Na, ppm | Conversion, % | Current Eff, % | Yield, % |
|---|---|---|---|---|---|---|---|---|---|
| | | | | | Vc, mole | | | | |
| NaVc | 0 | 3000 | 1.26 | 7.12 | 3.78(NaVc) | 29196 | | | |
| VC | 60 | 2863* | 0.51 | 4.51 | 1.46 | 15693 | 46.2 | 110.5 (?) | 38.6 |
| VC | 120 | 2726* | 0.89 | 3.81 | 2.43 | 8531 | 70.8 | 90.9 | 64.2 |
| VC | 180 | 2589* | 1.27 | 2.81 | 3.29 | 1118 | 96.2 | 86.7 | 87.0 |
| VC | 240 | 2451* | 1.36 | 2.09 | 3.33 | 140 | 99.5 | 75.5 | 88.2 |
| VC | 280 | 2360 | 1.35 | 2.01 | 3.19 | 80 | 99.7 | 64.5 | 84.3 |
| NaOH | | | | | NaOH, mol | | | | |
| NaOH | 0 | 3000 | 0.50 | 12.9 | 1.50 | | | | |
| NaOH | 60 | 3091* | 0.83 | 13.1 | 2.57 | | | 80.6 | |
| NaOH | 120 | 3182* | 1.02 | 13.02 | 3.25 | | | 65.4 | |
| NaOH | 180 | 3273* | 1.16 | 13.00 | 3.80 | | | 60.6 | |
| NaOH | 240 | 3364* | 1.24 | 13.00 | 4.17 | | | 60.5 | |
| NaOH | 280 | 3425 | 1.24 | 12.98 | 4.25 | | | 55.6 | |

*Volumes are estimated from the initiate and final volume, suppose the volume change is linear upon the running time.

Commercial BP membrane

| | Time, min | Vol, ml | Conc, N | PH | Vc, mole | Na+, ppm | Conversion, % | Current Eff, % | Yield, % |
|---|---|---|---|---|---|---|---|---|---|
| NaVc | 0 | 3000 | 1.26 | 7.47 | 3.78(NaVc) | 30516 | | | |
| Vc | 60 | 2898* | 0.50 | 4.39 | 1.45 | 17262 | 43.4 | 99.4 | 38.3 |
| Vc | 120 | 2796* | 0.90 | 3.72 | 2.52 | 6804 | 77.7 | 85.3 | 66.6 |
| Vc | 180 | 2695* | 1.22 | 2.69 | 3.29 | 926 | 97.0 | 79.0 | 87.0 |
| Vc | 240 | 2593* | 1.24 | 2.120 | 3.22 | 134 | 99.6 | 65.0 | 85.1 |
| Vc | 280 | 2525 | 1.29 | 2.039 | 3.26 | 114 | 99.6 | 59.2 | 86.2 |

| | Time, min | NaOH, ml | NaOH, N | pH | NaOH, mol | Current Eff, % |
|---|---|---|---|---|---|---|
| NaOH | 0 | 3000 | 0.50 | 13.07 | 1.50 | |
| | 60 | 3096* | 0.85 | 13.31 | 2.63 | 77.7 |
| | 120 | 3193* | 1.12 | 13.38 | 3.58 | 70.4 |
| | 180 | 3289* | 1.32 | 13.41 | 4.34 | 68.3 |
| | 240 | 3386* | 1.34 | 13.38 | 4.54 | 61.4 |
| | 280 | 3450 | 1.34 | 13.32 | 4.62 | 56.8 |

*Volumes are estimated from the initiate and final volume, suppose the volume change is linear upon the running time.

Comparison of Commercial BP membrane, Back-to-back bipolar of the invention, and published data regarding the Commercial BP membrane (from a paper of Lixin Yu, et al; Large Scale experiment on the preparation of Vitamin C from sodium ascorbate using bipolar membrane electrodialysis. Chem. Eng. Comm., 2002, Vol. 189(2) pp 237-246)

| | | | Power | | |
|---|---|---|---|---|---|
| | | | consumption | | |
| Bipolar | Conversion % | Current eff, % | KWh/kg Vc | Yield, % | Purity of Vc |
| Comm. BP | 99.6 | 59.2 | 0.70* | 86.2 | >99 |
| Back-to-Back | 99.7 | 64.5 | 0.88* | 84.3 | >99 |
| Comm. BP | 99.0 | 70 | Less than 1.0 | 87.5 | >95 |
| (published) | | | | | |

*The power consumption per kg of Vc is shown. In a practice, the separated caustic can be applied elsewhere in a treatment line, and the power consumption can be calculated for each of the useful separated or purified component processes to evaluate the operating costs and economics of a BP electrodialysis process.

Discussion:

1. The runs went smoothly. The voltage drop of the back-to-back bipolar membrane was 0.6-1.0 V at steady state, but the voltage drop for the commercial BP membrane was variable. Sometimes the voltage drop of the commercial BP membrane appeared negative for unexplained reasons.

2. The product ascorbic acid produced in the acid cell was very pure, having only about 100 ppm sodium ion in the solution, both for the commercial BP membrane and for the back-to-back membrane.

3. The current efficiency for the commercial BP membrane was 59.2%, and that of the back-to-back membrane was 64.5%.

4. The yield ( e.g., ascorbic acid recovery) was 86.2% for the commercial BP membrane, and that of the back-to-back membrane was 84.3%.

5. The total voltage of the stack using the commercial BP membranes was about 13 volts, while the voltage for the back-to-back bipolar membrane stack was as high as 19 volts at steady state, resulting in higher power consumption of the prototype back-to-back membrane (see data in Table above).

6. The yields of ascorbic acid converted from sodium ascorbate were around 85% indicating about 15% leakage of the ascorbic acid from acid chamber through the bipolar membrane into the caustic chamber; the sodium hydroxide would therefore contain some sodium ascorbate from the feed. In a commercial production plant treating ascorbate produced in an upstream fermentation process, the sodium hydroxide with sodium ascorbate could be returned to the fermentation process to enhance the overall yield. It was noted that when running with commercial bipolar membranes in the stack, the sodium hydroxide solution was clear, but when running the back-to-back bipolar membrane stack, the sodium hydroxide become brownish in color. The mechanism of coloration will require some elucidation. In a different test arrangement, sodium hydroxide solutions were brown in color for both the commercial bipolar membrane and for the back-to-back bipolar membrane stack treatments.

7. Tests may be carried out to evaluate the effective life of the back-to-back bipolar membrane in various environments, to test for trace amounts of catalyst appearing in the acid solution over the course of operation, and to optimize the lifetime and activity of the catalyst.

### EXAMPLE 6

### Recovery of Lactic acid, BtB Membrane with Co⁺⁺ Catalyst

In this series, a 9×10 stackpack run was conducted to convert sodium lactate to lactic acid using the BtB bipolar membranes with a cobalt catalyst. The commercial BP membrane run under similar conditions was used for comparison.

Stack configuration:

Bipolar membrane: 5 CR61CMP/AR103QDP (test) or Tokuyama BP-1 (commercial).

Anion membrane: 6 CR69EXMP, 9×10″.

The membranes were assembled in a two-compartment/cell stack. Sodium lactate (NaLa) was run in the acid chamber and converted to lactic acid, while sodium hydroxide was run in the caustic and electrode chambers.

Running conditions:

| | NaLa, | NaOH | Run | Voltage | Current |
|---|---|---|---|---|---|
| | (1 N) | (0.7 N), | Time, | of 5 | density, |
| | ml | ml | min | cell, V | mA/cm² |
| Back to back | 3000 | 4000 | 174 | 10-16 | 30 |
| Comm. BP | 3000 | 4000 | 180 | 8-12 | 30 |

Detailed results are shown in the Table below:

Ionics Back-to-back BP Membrane

| | Time, min | Vol, ml | Conc, N | PH | | Na, ppm | Conversion, % | Current Eff, % | Yield, % |
|---|---|---|---|---|---|---|---|---|---|
| | | | | | HLA, mole | | | | |
| NaLa | 0 | 3000 | 1.00 | 6.34 | 0.00 | 23134 | | | |
| HLA | 75 | 2772* | 0.52 | 3.85 | 1.44 | 9978 | 57.0 | 88.3 | 48.0 |
| HLA | 123 | 2625* | 0.88 | 2.85 | 2.31 | 2655 | 88.5 | 86.3 | 77.0 |
| HLA | 164 | 2500* | 0.99 | 2.093 | 2.48 | 323 | 98.6 | 69.4 | 82.5 |
| HLA | 174 | 2470 | 1.02 | 2.030 | 2.52 | 219 | 99.1 | 66.5 | 84.0 |
| NaOH | | | | | NaOH, mol | | | | |
| NaOH | 0 | 4000 | 0.68 | 13.41 | 2.72 | | | | |
| NaOH | 75 | 4086* | 0.95 | 13.33 | 4.13 | | | 86.2 | |
| NaOH | 123 | 4141* | 1.19 | | 4.93 | | | 82.5 | |
| NaOH | 174 | 4200 | 1.25 | 13.15 | 5.25 | | | 66.8 | |

*Volumes are estimated from the initiate and final volumes, assuming that the volume change is linear in run time.

Commercial BP Membrane

| | Time, min | Vol, ml | Conc, N | PH | HLA, mole | Na+, ppm | Conversion, % | Current Eff, % | Yield, % |
|---|---|---|---|---|---|---|---|---|---|
| NaLa | 0 | 3000 | 1.00 | 7.73 | 3.00 | 23088 | | | |
| (Hla) | 160 | 2600 | 0.89 | 3.422 | 2.31 | 595 | 97.4 | 62.9 | 77.1 |
| | 180 | 2550 | 0.95 | 2.791 | 2.42 | 263 | 98.9 | 60.3 | 80.8 |

| | Time, min | NaOH, ml | NaOH, N | pH | NaOH, mol | Current Eff, % |
|---|---|---|---|---|---|---|
| NaOH | 0 | 4000 | 0.70 | 13.41 | 2.80 | |
| | 160 | 4200 | 1.18 | 13.33 | 4.96 | 58.6 |
| | 180 | 4250 | 1.20 | 13.28 | 5.10 | 57.2 |

Discussion:

1. The runs went smoothly. The voltage drop of back-to-back bipolar membrane was 0.5-0.8 V at steady state, that for the Commercial BP was less than 0.8 Volt. Sometimes the voltage drop of the Commercial BP appeared negative. The mechanism of this anomaly is not apparent.

2. The products of lactic acid were very pure both in commercial BP and the back-to-back membrane.

3. Current efficiency for the commercial BP was 60.3%, and for the back-to-back membrane was 66.5%.

4. Yield of lactic acid recovery was 80.8% for the commercial BP membrane, while the back-to-back membrane was higher at 84.0%.

5. The total voltage of commercial membrane stack was about 12-15 volts, lower than for the back-to-back bipolar membrane stack (as high as 16-21 volts). The power consumption of the back-to-back membrane was thus somewhat higher than that of the commercial BP membrane.

### EXAMPLE 7

### Recovery of Lactic Acid from Ammonium Lactate, BtB membrane with Co⁺⁺

A 9×10 stackpack run was conducted for conversion of ammonium lactate to lactic acid using back to back bipolar membrane with cobalt catalyst. This is the 11^{th} run of the back-to-back bipolar membrane. A commercial BP membrane run as described above was used for comparison.

Stack configuration:

Bipolar membrane: 5 CR61CMP-M09112A/AR103QDP-E03153B or Tokuyama BP-1.

Anion membrane: 6 AR103QDP, 9×10″.

The membranes were assembled as two compartment/cell stack. Ammonium lactate was run in the caustic chamber, and lactic acid in the acid chamber. Both electrode chambers ran with sodium sulfate.

Running conditions:

| | | | | | Current | Voltage |
|---|---|---|---|---|---|---|
| | NH4La, | H2O, | Run Time, | Voltage | density, | of 5 |
| | ml | ml | min | drop, V | mA/cm² | cell, V |
| Back to back | 3000 | 2000 | 180 | 1.4-2.5 | 30 | 20-23 |
| Comm. BP | 3000 | 2000 | 170 | <1.5 | 30 | 14-20 |

Detailed results of operation are shown in the Table below:

Ionics Back-to-back BP membrane

| | Time, min | Hla, ml | HLa, N | pH | Hla, mole | NH₄+, ppm | NH₄ in Hla, mole % | Current Eff, % | Yield, % |
|---|---|---|---|---|---|---|---|---|---|
| Hla | 0 | 2000 | 0.00 | 5.3 | 0.00 | | | | 0 |
| | 60 | 2133 | 0.49 | 2.32 | 1.05 | 281 | 3.2 | 97.4 | 34.8 |
| | 120 | 2266 | 0.90 | 2.26 | 2.04 | 540 | 3.3 | 85.8 | 68.0 |
| | 170 | 2378 | 1.00 | 2.48 | 2.38 | 846 | 4.7 | 78.7 | 79.3 |
| | 180 | 2400 | 1.00 | 2.51 | 2.40 | 915 | 5.1 | 75.0 | 80.0 |

| | | | | | NH₄OH, |
|---|---|---|---|---|---|
| | Time, min | Vol, ml | Conc, N | pH | mole |
| NH4OH | 0 | 3000 | 0.00 | 9.30 | 0 |
| (NH4La) | 60 | 2800 | 0.22 | 9.73 | 0.616 |
| | 120 | 2600 | 0.44 | 10.26 | 1.144 |
| NH4OH | 180 | 2400 | 0.47 | 10.82 | 1.116 |

*Volumes are estimated from the initial and final volumes, assuming that the volume change is linear in run time.

Commercial BP membrane

| | Time, min | Hla, ml | HLa, N | pH | Hla, mole | NH4+, ppm | NH4 in Hla, mole % | Current Eff, % | Yield, % |
|---|---|---|---|---|---|---|---|---|---|
| Hla | 0 | 2000 | 0.00 | 7.02 | 0.00 | | | | 0 |
| | 60 | 2240 | 0.54 | 2.53 | 1.21 | 234 | 2.4 | 89.6 | 40.3 |
| | 120 | 2480 | 0.87 | 2.79 | 2.16 | 578 | 3.7 | 81.5 | 71.9 |
| | 150 | 2600 | 0.90 | 2.97 | 2.34 | 769 | 4.7 | 73.6 | 78.0 |
| | 170 | 2680 | 0.95 | 3.07 | 2.55 | 994 | 5.8 | 72.2 | 84.9 |

| | Time, min | Vol, ml | Conc, N | pH | NH₄OH, mole |
|---|---|---|---|---|---|
| NH4OH | 0 | 3000 | 0.00 | 8.90 | |
| (NH4La) | 60 | 2682 | 0.38 | 9.84 | 1.02 |
| | 120 | 2365 | 0.50 | 10.77 | 1.18 |
| | 150 | 2206 | 0.47 | 10.88 | 1.04 |
| NH4OH | 170 | 2100 | 0.36 | 10.85 | 0.76 |

Discussion:

1. The runs were smoothly. The voltage drop of the back-to-back bipolar membrane was 1.4-2.5 V at steady state, and that of the commercial BP was less than 1.5 Volts, sometimess going into negative values. It is not apparent what mechanism connected with the commercial BP membrane is responsible for this. After the runs, it was found that the surface of the AR103 membrane was rough both in cases of back-to-back BP and the commercial BP stack. The roughening may result from the counter ion in the AR103 membrane changing from chloride to lactic ion.

2.The product lactic acid contained about 5% by mole of ammonium ion. The distributor of the commercial BP membrane has stated that up to 10% by mole of neutral ammonia may enter the acid chamber by diffusion treatment units having this configuration of a BP/anion two compartment treatment cell.

3. Current efficiency of the commercial BP membrane was 72.2%, while that of the back-to-back membrane was 75%.

4.The yield of lactic acid recovery was 84.9% for the commercial BP membrane, while and of the back-to-back membrane was 80.0%.

5. Some ammonium hydroxide was decomposed in the process, so an attempt was made to calculate the current efficiency for caustic solution.

6. The total voltage of the commercial BP stack was about 20-26 volt, and the voltage drop for back-to-back bipolar membrane stack was up to 24-28 volt. This corresponds to a higher power consumption for the back-to-back membrane than for the commercial BP membrane.

As seen in the foregoing examples, the membranes and membrane fabrication process of the present invention provide a simple and effective bipolar membrane that even in rudimentary prototypes attain excellent operating characteristics and show utility for treating, refining or converting a range of different industrially interesting feed stocks. By joining two sheets of opposite type ion exchange material, a robust and efficient bipolar membrane is obtained. The starting sheets, which are necessarily separately fabricated, may have their basic fabrication processes separately selected to produce physical and chemical characteristics in the ion exchange sheets that optimize the operation and/or strength of the bipolar membranes so produced. That is, properties such as porosity, exchange capacity, degree of polymerization and cross-linking, degree of functionality and amount of unreacted functional sites may all be varied, in addition to such features as thickness or the like, to provide faster or more effective diffusion of water to the junction region, rejection of solute ions, transport of ions out to the surface, or chemical resistance to such pH conditions and incidental species as occur in operation and within the membrane in different treatment processes. For many intended applications, it is preferred that the anion exchange membrane be an acid efficient or acid-blocker membrane, e.g., be formulated to resist transport of H+ (as described, for example, in U.S. Pat. No. 4,822,471). The use of a common chemical class or component (e.g. aromatic) as a backbone component or cross-linker in both underlying membranes has been found to be important in obtaining good bonding and membrane operating results. Preferably one or both of the underlying sheets of the bipolar membrane is reinforced, e.g., with fiber or textile.

The invention being thus disclosed, further variations and modifications will occur to those skilled in the art, including new methods of applying the bipolar membranes of this invention to the electrodialysis equipment, equipment operating protocols and applications of such equipment. For example, the reversible nature of the junction region bond allows one to implement novel clean-in-place procedures that include a step of de-bonding the laminated membrane in situ, then undergoing a cleaning operation. For example, one then may clean an assembled ED or treatment device by flowing acid, caustic or other agent in cells of the device with or without electrical power or reversal, and then re-bond the bipolar membrane by in situ operation as described above. All such variations, modifications and evident applications of the invention described herein are considered to be part of the present invention for which a patent is requested.

1. A process for forming a bipolar membrane, such process comprising the steps of:
juxtaposing an anion exchange membrane and a cation exchange membrane in face-to-face contact to form a two-membrane layered assembly,
current bonding the layered assembly to join the anion exchange membrane and cation exchange membrane together into a single bipolar membrane with a layer separation tear strength comparable to or greater than strength of said anion exchange membrane or said cation exchange membrane.

2. The process of claim 1, wherein said anion exchange membrane is a homogeneous membrane having an aromatic cross linker and aromatic quaternary ammonium groups, and said cation exchange membrane is a homogeneous membrane having an aromatic cross linker.

3. The process of claim 1, wherein the step of current bonding is performed by subjecting the layered assembly to pressure, and running current through the layered assembly.

4. The process of claim 1, further comprising the step of wetting a said membrane with metal salt solution prior to running said current so as to incorporate catalytic metal species into the single bipolar membrane.

5. The process of claim 1, wherein said anion exchange membrane and said cation exchange membrane are each self-supporting membranes.

6. The process of claim 1, wherein said anion exchange membrane and said cation exchange membrane are each homogeneous membranes.

7. A process for forming a bipolar membrane, the process comprising the steps of
providing a first membrane of a first ion exchange type formed as a homogenous membrane by crosslinking and exchange functionalization and containing aromatic material
providing a second membrane of a second ion exchange type formed formed as a homogeneous membrane by crosslinking and exchange functionalization and containing aromatic material
at least one of said first and said second membranes being a self-supported membrane
treating said first or second membrane with a multivalent metal salt solution
juxtaposing the first and second membranes in contact under pressure, and
running current through the juxtaposed first and second membranes to reversibly bond the first and second membranes into a bipoloar membrane.

8. A bipolar membrane having first and second exchange layers extending to opposed first and second surfaces,
said first exchange layer being substantially homogeneous material and functionalized with ion exchange groups of a first type
said second exchange layer being substantially homogeneous material functionalized with ion exchange groups of a second type
wherein the first and second layers are joined in contact without a bonding agent to form the bipolar membrane having a splitting junction region at an interface of said first and second layers, said region joining the first and second exchange layers with a peel strength greater than strength of said materials.

9. The bipolar membrane of claim 8, wherein the junction region is formed by running current greater than 15 mA/cm² through juxtaposed sheets of the first and the second layers.

10. The bipolar membrane of claim 8, wherein the bipolar membrane contains a transition metal distributed therein.

11. The bipolar membrane of claim 10, wherein the transition metal is precipitated in the anion exchange layer.

12. The bipolar membrane of claim 8, wherein the first and second layers are reversibly joined, being separable in a concentrated ionic solution.

13. The bipolar membrane of claim 12, wherein the separated first and second layers may be rejoined in said junction region by passage of current therethrough, which may optionally be performed repetitively in situ as the layers reside in an electrodeionization stack.

14. A bipolar membrane comprising
a first layer of a first substrate having first ion exchange type
a second layer of said first substrate having a second, opposite, ion exchange type,
the first and second layers being directly in contact with each other and joined by electrochemical bridge bonding between the first and second layers formed of said first substrate mediated by a multivalent catalyst species.

15. The bipolar membrane of claim 14, wherein said electrochemical bridge bonding reversibly and releasably joins the first and second layers.
